(19) United States
(12) Patent Application Publication
(10) Pub. No.: US 2007/0226705 A1
(43) Pub. Date: Sep. 27, 2007

(54) Wrap-up reads for logless persistent components

(75) Inventor: David B. Lomet, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/354,373

(22) Filed: Feb. 15, 2006

(51) Int. Cl. G06F 9/44

(52) U.S. Cl. 717/133

(57) ABSTRACT

Architecture that facilitates exactly-once application execution via a wrap-up procedure. A logless component (LLcom) processes a last-read activity (or wrap-up read) against external state when processing a method of a middle-tier environment. A client logging component logs results of the method to a client log. The wrap-up procedure of the LLcom is initiated to read external state. External state is read after all GIR requests have been processed but just before the method returns to the client. The LLcom method returns to the client at a point in the caller method that immediately issues the return for the method call. Subsequent client requests become replayable due to the logged results. With client logging, both idempotence of requests and guiding execution back to its original execution path is accomplished. Alternatively, logging can occur via a middle-tier decision service. In either event, the logging enables the middle tier to choose at which back end service it will next send a request will supporting exactly once execution.

### BACKGROUND

Enterprise applications must be highly available and scalable. This has classically required “stateless” applications that manage their states explicitly via transactional resource managers. “Stateful” applications, on the other hand, are more natural, easier to write, and hence, get correct. The execution state captures much of the application state without having to manifest it. This part of the state manages itself, and as a result, the programmer can better focus on the business logic. However, having the system manage state automatically has heretofore been considered too difficult and costly.

Robust applications enable enterprise systems to support highly available and scalable service. Such applications must survive system crashes and be re-deployable on other computers as the system changes and grows. Despite this dynamic activity, “exactly once” execution semantics should be provided. In other words, an application can start execution on one computer, that computer system crash, and then be redeployed on another computer, etc., and to the application client, it looks like a seamless execution in which the application executed exactly once without crashing or moving.

Letting business logic dictate how developers program their application is easy and natural. The resulting application is usually “stateful”. In the past, this has compromised availability and scalability. A stateful application has control state across transaction boundaries, incurring the risk of losing state should the system on which it executes crash. This creates a “semantic mess” that can require human intervention to repair the state and it results in long service outages.

Classic transaction processing insists that applications be stateless, which means “no meaningful control state” is retained across transactions. This stateless model forces an unnatural “string of beads” programming style where a program is rearranged to fit the model. In other words, the programmer manages the state by organizing the program to facilitate state management. The state information is stored in a database and/or transactional queue. An application must, within a transaction, first read its state from, for example, the transactional queue, then execute its logic, and finally, commit the step by writing its state back to a transactional queue for the next step. “State” is not avoided; rather, it is managed in a transactional way. Potential performance and scalability problems related to the message and log cost of two-phase commit may also be encountered which can affect performance and latency.

An application programmer thus faces a dilemma of having to choose between fast, easy development, resulting in applications that are more likely to be correct, implemented in a natural stateful programming style, but which fail to provide availability and scalability, and high availability and scalability via the stateless programming model, which adds to development time and makes correctness harder to achieve because of the need for explicit state management.

In one prior software technique, the system manages application state transparently by logging interactions between components, thereby guaranteeing exactly-once application execution. However, for middle tier session-oriented components, it is possible to avoid logging interactions in order for them to survive system crashes. Because there is no logging, performance of failure-free execution is excellent. Availability and scalability are possible with this prior technique, but require maintaining the log, forcing the log, and shipping of the log for recovery purposes. With performance, scalability, and availability being ever-present system aspects that demand improvement, the ability to avoid the need for logging in order to achieve scalability and availability of software components is desired.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention disclosed and claimed herein, in one aspect thereof, comprises a computer-implemented system that facilitates exactly-once application execution via a wrap-up procedure. The system includes a logless component (LLcom), a middle-tier component, for processing a last-read activity (or wrap-up read) against external state as part of processing at least one method of a middle-tier environment, and a logging component of a client for logging results of the method to a log.

A method of the LLcom is called from a persistent client. An internal wrap-up procedure of the LLcom is initiated to read an external state. This wrap-up procedure is executed only after all GIR (generalized idempotent request) requests have been processed. External state is read in the wrap-up procedure after all GIR requests have been processed but just before the method returns to the client, and no changes to the internal state of the LLcom are made as a result of the wrap-up read.

The innovation facilitates the processing of read-only and non-read-only LLcom methods. The client ensures that results returned from the LLcom method are logged and forced. Thus, access is only needed- to the local client log to retrieve the results for replay. Despite the lack of idempotence, it is possible to permit such read-only LLcom methods. The client can now avoid repeating the call to the LLcom during its replay, as the client already has the answer it needs on its local client log.

In a more generalized case, the client (or persistent component-Pcom) can be exploited to perform the logging in a more general setting than read-only LLcom methods. For LLcom methods which perform some updates via GIR's, a last “wrap-up” read can be permitted as the last activity after all GIR requests have been processed but just prior to the method returning to the client. Subsequent client requests become replayable because of the logging at the client Pcom. The wrap-up procedure returns to a part of the LLcom method that immediately issues the return for the method call. With client logging, should the LLcom method be replayed, reading the original logged result will guide execution back to its original execution path.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that provides a wrap-up procedure which facilitates exactly-once application execution, in accordance with an innovative aspect.

FIG. 2 illustrates a methodology of providing a wrap-up procedure for exactly-once execution according to a novel aspect.

FIG. 3 illustrates a system where replay of an e-proc impacts an LLcom based only on its GIR request.

FIG. 4 illustrates an example application that shows what can be supported by logless session-oriented components that employ wrap-up activity.

FIG. 5 illustrates a system that employs a decision service for logging information at a location other than a client.

FIG. 6 illustrates a block diagram of a computer operable to execute the disclosed wrap-up architecture.

FIG. 7 illustrates an alternative system that employs wrap-up activity in accordance with an innovative aspect.

FIG. 8 illustrates a schematic block diagram of an exemplary two-tier client/server computing environment that can employ wrap-up activity in accordance with another aspect.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Beginning with a brief introduction, programming models can contain a notion of middle-tier components, logless middle-tier components (LLcom's), persistent components (Pcom's), and client components, and which one or more of the components can be stateful. Components declared as Pcom's survive system crashes. Components declared as transactional (Tcom's) should have a testable transaction state, as in transaction processing and e-transactions (which focus primarily on reducing state management while placing restrictions on how applications can be structured and deployed). Other component types can have other requirements. Pcom's can serve multiple calls from multiple clients, send messages to other Pcom's or Tcom's, etc., while providing exactly-once semantics.

In order for a programming model to ensure that Pcom's persist across system crashes, it logs the interactions of each Pcom so that the Pcom can be deterministically replayed, using the log to capture nondeterministic events and their potentially nondeterministic arrival order. A Pcom log also permits it to be recovered independently of other components. The logging is what permits it to satisfy the requirements of what are called “interaction contracts”. These contracts require components to guarantee that their state and messages will survive system crashes and provide exactly-once executions. It is this logging that permits a Pcom to engage in relatively unconstrained activity with other Pcom's and Tcom's while maintaining persistence across crashes.

An LLcom is a session-oriented component type that avoids logging while being persistent and stateful. The LLcom exploits the logging done already by other components. The LLcom can be called multiple times and interact with a number of backend systems involving a number of transactions, while retaining its persistent state. Because LLcom's support stateful applications, the programmer can focus on business logic instead of system issues. Moreover, LLcom's can be easily redeployed across an enterprise system, since no log needs to be shipped. In addition to their availability and scalability advantages, LLcom's perform better during normal execution because no logging is required; indeed, no interception of messages is required.

To provide persistence without logging, LLcom's need to be restricted in what they can do. According to one restriction, all interactions initiated in the middle tier should be idempotent. That is, an interaction can be replayed multiple times while only producing a state change exactly once, and always returning the same result. Further, due to the absence of a middle-tier log, an LLcom cannot shorten its recovery time by taking a checkpoint.

LLcom's can be made more capable by introducing the capability of the LLcom to read system state without the need for these reads to be idempotent. Additionally, checkpointing can be employed to shorten recovery time of a failed LLcom. With respect to reading system state, the notion of idempotence that is provided at backend services can be generalized. This enables the read results to vary without changing the backend state, while guiding the middle tier state back to a replayable trajectory. These read results cannot affect the choice of which backend service to visit. In addition, “wrap-up” reads are described that do not impact middle-tier state in the current method call, but can return results to the client that impact subsequent execution of both client and middle tier components. In particular, a wrap-up read can impact the choice of backend service visited in the next LLcom method invocation. In each case, the read is followed by logging that captures the logical impact of the first successful read execution. Even if the read, when repeated produces different results, the first read will govern subsequent execution.

The shortened recovery time via checkpointing permits more flexible deployment and higher availability. Since there is no log directly associated with LLcom's, the definition of checkpoint is extended to enable client Pcom's to perform the checkpoint process for the LLcom. The costs associated with maintaining the log, forcing the log, and shipping the log are all eliminated for the middle-tier component, and are instead incurred by the client Pcom, but much of these costs are necessary in any event to ensure that the client is recoverable.

The subject of this invention focuses on wrap-up (wu) procedures (or wu-proc's) and the associated wrap-up reads (or wu-reads). As indicated supra, wu-reads do not impact middle-tier state in the current method call, but can return results to the client that impact subsequent execution of the client and the middle-tier components.

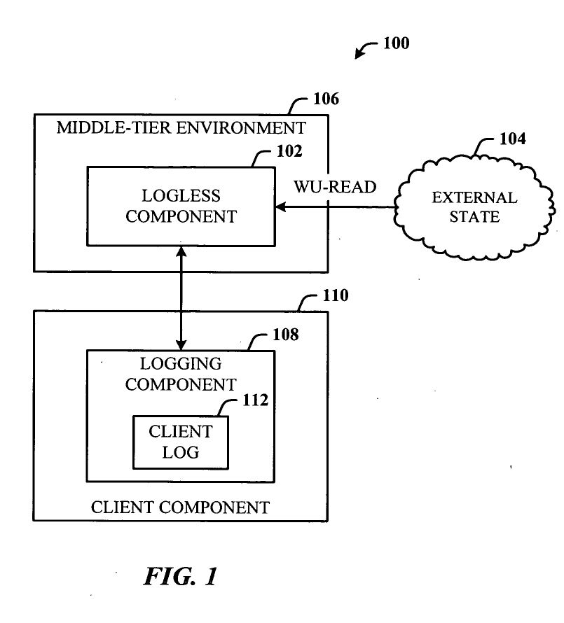

Referring initially to the drawings, FIG. 1 illustrates a computer-implemented system 100 that provides a wrap-up procedure which facilitates exactly-once application execution, in accordance with an innovative aspect. The system 100 includes a logless component 102 for processing a last-read activity (or wrap-up read) against external state 104 as part of processing of at least one method of a middle-tier environment 106, and a logging component 108 of a client 110 for logging results of the method to a log 112.

The system 100 facilitates the processing of read-only and non-read-only LLcom methods. The client 110 ensures that results returned from the LLcom method are logged and forced as needed. Thus, read access is only needed to the local client log 112 to retrieve the results for replay. For example, consider an LLcom read-only method, perhaps a method call that checks airline flights and prices, and returns that result to the client 110 (which is a Pcom). The client 110, perhaps after interaction with the user, proceeds to make a subsequent call indicating the user's choice of flights and intention to purchase tickets. The read-only method is not idempotent. Thus, upon replay, the flights returned might be very different.

Despite the lack of idempotence, it is possible to permit such read-only LLcom methods. Upon returning the result to the client Pcom 110, the client 110 should ensure that the results returned are logged (and forced) prior to its initiating a subsequent call to ensure its deterministic replay. The client 110 can now avoid repeating the call to the LLcom during its replay, as the client 110 already has the answer it needs on its local client log 112. The method call itself can be replayed without any complication, since it is read-only.

Client replay remains effective so long as the logged result of the original invocation is used during replay. Accordingly, the client Pcom logs the results of the first execution of the LLcom method. When the LLcom method is re-executed, its returned result is ignored and replace with the results of the first execution. Thus, this LLcom method is not idempotent during re-execution. It is only “idempotent” after its returned results are replaced by the results of the first execution logged at the client. The client Pcom 110 can force the log 112 prior to revealing state via a subsequent update, since the read-only method execution results in a non-deterministic event that is not captured in any other way.

Note that the result of executing an LLcom method containing a wu-read can be different when the method is re-executed during a replay/recovery process.

The client 110 can be exploited to perform the logging in a more general setting than read-only LLcom methods. For LLcom methods which perform some updates via GIR (generalized idempotent request) requests, a read can be permitted as the last activity (a “wrap-up” activity), after all GIR requests (which include idempotent requests as a special case), just prior to the method returning to the client. GIR requests ensure that state changes at the backend occur exactly once, with the first successful executions prevailing. Note, also that a read-only method is a special case where there are no GIR requests. So long as this read activity does not change the state of the LLcom, it will have no further impact on LLcom state, except via subsequent client requests.

Subsequent client requests become replayable because of the logging at the client Pcom. However, as with exploratory reads, which are described in more detail herein below, it should be ensured that the wu-read does not have any impact on subsequent LLcom state except via the information that is logged, in this case by the client Pcom 110. The wu-proc disclosed herein is a technique similar to exploratory procedures (denoted e-proc's, and which are also described in greater detail infra), will work here as well as for the exploratory reads. A wu-proc can read external state (without idempotence) and freely update its local variables. When it returns, it returns to a part of the LLcom method that immediately issues the return for the method call. The only thing the LLcom 102 can do here is to include the results from the wu-proc in what the LLcom 102 returns to its caller (the client P-com). It cannot alter the state of the LLcom 102. During replay, client Pcom logging guides execution back to its original execution path following the LLcom method call.

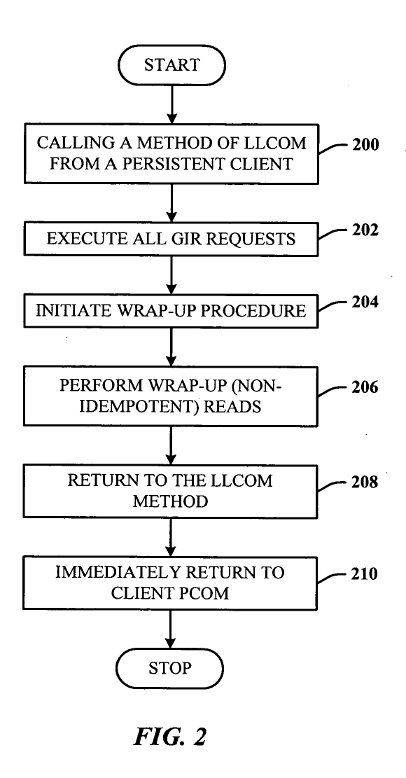

FIG. 2 illustrates a methodology of providing a wrap-up procedure for exactly-once execution according to a novel aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, a method of the logless component is called from a persistent client. At 202, all GIR requests are executed. At 204, the wrap-up procedure is initiated. At 206, the wrap-up (non-idempotent) reads are performed. At 208, program flow returns to the LLcom method. At 210, the method immediately returns to the client Pcom.

Pcom logging removes the nondeterminism resulting from the order of calls to it. Its methods can be invoked in a nondeterministic order from an undetermined set of client components. Typically, neither the next method invoked nor the identity of the invoking component is known. However, both of these aspects can be captured in Pcom's via logging.

As indicated supra, LLcom's have no log upon which to rely. However, by restricting an LLcom to serving only a single client Pcom (that is, the LLcom is made “session-oriented”) the fact that the client Pcom is already capturing this sequence of method calls can be exploited. Thus, an LLcom should be initiated from a client that is a Pcom and only serve calls from this initiator component. Since a Pcom has its own log, it is capable of being recovered based on its local log. When the client Pcom recovers, it also recovers the sequence of calls to an LLcom with which it interacts. This single client limitation results in an LLcom that can play the role of a J2EE (Java 2 Enterprise Edition) session bean, for example.

With respect to calls from an LLcom, the LLcom's execution should, based on its prior execution, be able to identify the next interaction as to the kind of interaction (e.g., send or receive) and with which component. If it is a message send, then this is accomplished via replay, as it is the component's deterministic execution that leads to the message send. It is the receive interactions for which determinism needs to be provided.

Truly nondeterministic receives should be excluded. However, for a receive message that is part of a request/reply setting, the reply (a message receive) is from the recipient of the request message, and the reply message is awaited at a deterministic point in the component execution. A Pcom can fail after some number of interactions without logging, and yet be recovered. This means that one or more interactions subsequent to those on the log may have occurred and not have been logged.

In order to deal with this, both components of an interaction should make the interaction durable in some way. However, in interactions between Pcom's and, between a Pcom and a Tcom, at least initially, only a message sender has met the guarantee. An interaction can be made idempotent if it is required of components called by an LLcom to provide the same guarantees for their reply messages. That is, to eliminate duplicates so as to enforce “exactly once” execution semantics, and to return on request the result message that they have promised to maintain about the interaction, for example, a committed interaction contract (CIC) or a transaction interaction contract (TIC). When the interaction is idempotent, it can be replayed multiple times while only producing a state change exactly once, and always returns the same result message. It is idempotence of the calls by LLcom's to “backend” servers that describes this “reliable” interaction replay.

Accordingly, what an LLcom needs is idempotence from the backend servers for its requests. Replay of the LLcom will retrace the execution path to the first called backend server invoked. That server is required, via idempotence, to only execute the request once, and to return the same reply message. That same reply message permits the LLcom to continue its deterministic replay to subsequent interactions, etc.

Restricting an LLcom such that it cannot read system state outside of an idempotent interaction imposes a strong requirement on the backend server. It should guarantee (e.g., via logging or transactional queues) that it will remember requests that have been successfully executed so as to be able to detect duplicate requests by not re-executing them, and it should return the same output results. Non-idempotent reads are precluded because their results during replay can differ from the initial execution, leading to divergent execution paths. An improvement to this is to permit non-idempotent reads if exactly-once execution can be guaranteed at backend servers that return the same result despite receiving different argument values, and forcing of the execution path of the LLcom back to the path of its initial execution, hence, “wiping out” the effects of the non-idempotent reads on subsequent LLcom state.

Also described herein is a notion of exploratory reads. Exploratory reads are reads that precede an invocation of a request to a backend server. These reads permit the middle-tier application to specify certain items, for example, items included in an order, the pickup time for a rental car, the departure time for a subsequent flight, etc. In each case, the read is followed by the sending of a GIR request to a backend server. It is desired that the backend server is “idempotent” even if exploratory reads are different on replay than during the original execution. Additionally, exploratory reads should be prevented from having a further impact, so that the execution path of the LLcom is returned to the path of its original execution.

Typically, in the transaction processing community and in the description of Tcom's provided herein, the responses of backend servers are considered to be idempotent. Thus, if a duplicate request is received, it will not be executed. Rather, it will be recognized as a duplicate, and a reply message identical to that of the first execution will be returned. In practice, “idempotence” is typically achieved not by remembering an entire request message, but rather by remembering a unique request identifier that was an argument, perhaps implicit and generated by, a TP (transaction processing) framework for example. This technique provides idempotence, and should an identical message arrive at a server, it will detect it as a duplicate and return the correct reply.

Requiring request identifiers to detect duplicate requests permits the support of what is referred to herein as a generalized idempotence property. Thus, a server supporting GIR's permits each resend of a message with the same request identifier to have other arguments of the message that are different. This is exactly what is desired in order to permit exploratory reads to have an impact on backend requests.

Idempotent requests (IR's) satisfy the property:
IR(IDₓ,Aₓ)=IR(IDₓ,Aₓ)∘IR(IDₓ,Aₓ),
where IDₓ denotes the request identifier, Aₓ denotes the other arguments of the request, and “∘” is used to denote composition, in this case, multiple executions.

GIR's, however, satisfy a stronger property:
GIR(IDₓ,A₁)=GIR(IDₓ,Aₓ)∘GIR(IDₓ,A₁)
where A₁ represents the values of the other arguments on the first successful execution of the request. Thus, it is the effect produced and the result returned by the first successful execution of a GIR that determines the effect of subsequent executions, even when the other arguments Aₓ are different from the original arguments.

GIR requests ensure that state changes at the backend occur exactly once, with the first successful executions prevailing. That it also returns the reply produced by this first execution makes it possible to both exploit the reply to control the subsequent course of calling LLcom execution and to limit the impact of the exploratory reads.

Following is a description of how to deal with the non-repeatability of reads at the LLcom. This requires limiting the propagation of the effects of these reads in some way. There are several ways this might be done, one of which introduces a notion of exploratory procedures.

Whenever there is to be an exploratory read, it should be performed within an exploratory procedure (e-proc). An e-proc ends its execution with a GIR request to the same server, using the same request identifier on all execution paths. That is, it is impossible to exit from the exploratory procedure in any way other than the execution of a GIR request to the same server using the same request identifier. Because the request is a GIR request, it can have arguments other than its request identifier that differ from call to call, and it is guaranteed to return the same result as its first successful execution. So the exploratory reading within the e-proc can have an impact on the GIR request, determining on its first execution, what the GIR request will do.

A reason for restricting exploratory reads to e-proc's is to limit their impact to only the arguments of the GIR request. As a way of helping to achieve this, variables local to a procedure have procedure activation scope, and hence, disappear when the procedure exits. Accordingly, exploratory reads can be permitted to update local variables of the e-proc. However, non-local variables are not permitted to be updated from within an e-proc, prior to its GIR request.

It is desired that the GIR request be able to influence subsequent LLcom execution. Therefore, the e-proc is permitted to return results, and set output parameters, based on the results of the GIR request. The GIR request, should it be replayed, produces the same output as its original execution. Hence, regardless of the number of times the e-proc is replayed, its impact on LLcom execution following its return will be dependent only on its contained GIR reply, which is always the same.

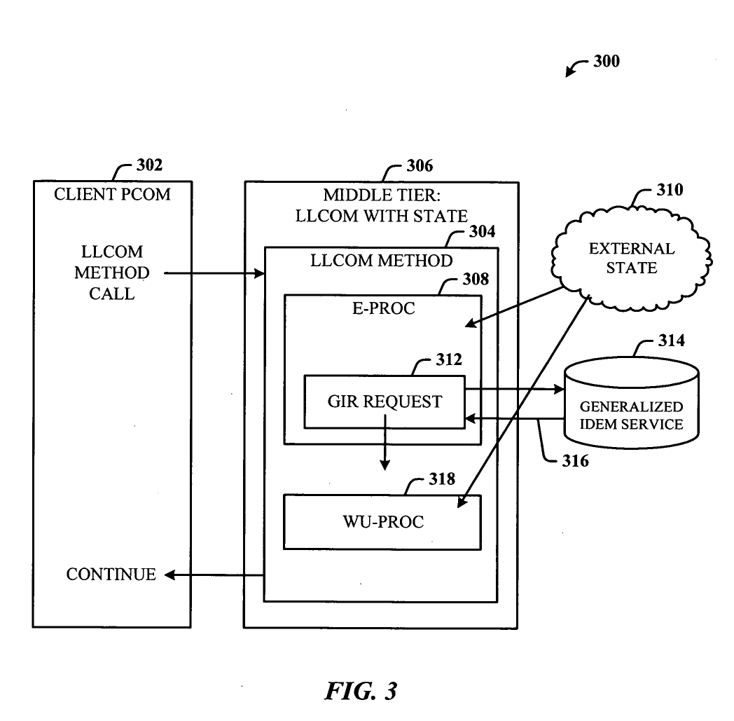

FIG. 3 illustrates a system 300 where replay of an e-proc impacts an LLcom based only on its GIR request. Here, a client Pcom 302 issues a call (denoted LLcom Method Call) for an LLcom method 304 of a stateful middle-tier LLcom 306. The LLcom method 304 performs some local computation, and then calls an e-proc 308. The LLcom 306 can now read external state 310. At the end of the e-proc procedure 308, a GIR-request 312 is made to a generalized idempotent backend service 314. A reply 316 from the backend service 314 determines the result of the e-proc, which is passed from the e-proc 308 to the LLcom method 304 where it can be used to change the state of the LLcom 306.

Where the LLcom method 304 allows updates via the GIR requests, the last activity is reading the external state. After execution of the last GIR request 312, the LLcom method 304 performs one last procedure by initiating the wrap-up activity using a wu-proc 318. As indicated above, the wrap-up activity occurs after the last GIR request has been processed, but just before the method 304 returns to the client 302.

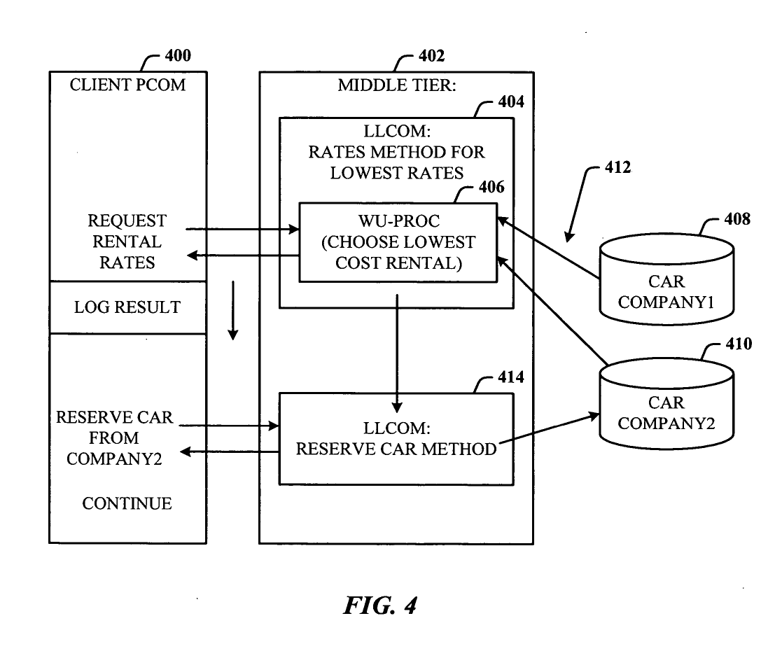

FIG. 4 illustrates an example application that shows what can be supported by logless session-oriented components that employ wrap-up activity. Here, client logging is utilized with a read-only method, to enable choosing with which car rental company to make a reservation. In this example, a client 400 initiates a session with a middle-tier service 402. An LLcom read-only method 404 that checks rental care rates is invoked. In one implementation, the session method 404 can be configured to access and/or load customer preferences derived from a customer database (not shown) into session variables, and then return to the client 400.

The method 404 involving the rental car is focused on here, because it will exploit wrap-up reads and a wu-proc. Notably, logging of the rate information at the client 400 occurs before choosing from which rental car company to make the reservation. Having logged that information, the corresponding car rental website can be accessed to place the reservation. Of further note is that the client log needs to be forced before the “reserve” call is made, in order for deterministic replay to be guaranteed.

In operation, the client 400 issues a request for rental rates to the middle-tier service 402, which invokes the rental car LLcom read-only method 404. The first method called authenticates the client 400 using an idempotent request to the customer database. The method 404 includes a wu-proc 406 that executes wrap-up reads to read rate information from rental car company databases, for example, a first database 408 (denoted CAR COMPANY1) and a second database 410 (denoted CAR COMPANY2). These reads 412 are non-idempotent wrap-up reads, in that upon replay, the information returned could be different. The results are then passed from the service 402 to the client 400 and logged.

As processing continues (indicated by the downward arrow), the client 400 initiates a reservation request to the service 402. In response, a middle-tier LLcom rental car method 414 is invoked that chooses the lowest cost rental and reserves the car from the company (CAR COMPANY2) associated therewith. The reservation information is then passed back to the client 400.

A critical element is what happens after the reservation request has been sent to the second car rental company 410 should the middle-tier component 402 crash. If it crashes, then the session component should be replayed. When replaying the rental method and checking once again for the lowest rate rental car, because this read is not idempotent, the result returned may indicate that the previously returned lowest rate deal is not currently offered. Despite this, the client will replay the Reserve Car Method call with information that results in the middle tier LLcom Reserve Car Method 414 contacting Car Company2 410, based on the result of the information resulting from the initial execution of the Wu-Proc 406.

This is one example of how a session-oriented component can exploit wrap-up reads, to choose the backend site whose state will be altered, and make the first execution be the only execution that counts via logging at the client 400. Persistence of the LLcom 404 is assured via replay, and does not require any logging in the middle-tier component 402.

Idempotent backend web services or client Pcom's can help broaden the functionality permitted of LLcom's so that they can do non-idempotent reads. To do this required imposing some structure on LLcom's. Such structure is sometimes considered a programming model. Despite this, it is maintained that the result is a simple stateful programming model.

Exploratory reads should be followed by calls to backend web services so that the results can be captured stably. This has been discussed for the web services needed by the business logic of the application. This paradigm requires that the web service be selected prior to the execution of the e-proc that implements the exploratory read functionality.

In order to use what is read to help decide which service to invoke, the wrap-up procedure can be used. That is, the read is performed, perhaps in a read-only method of the LLcom, and the needed information returned to the client Pcom, which information usually is only a small part of what is read. This is similar to returning a cookie to the client and is a viable technique that permits the middle tier to avoid logging. Unlike with cookies, however, the middle-tier component is not stateless. So the cookie does not need to capture the entire state, but only enough information to “direct” the replay to the correct backend web service. Capturing the entire LLcom state via a checkpoint is done much more rarely, is used only to improve recovery time, and it is done transparently to the application logic.

Client Pcom's are not the only place where the results of reads can be made stable. There may well be times when the “middle tier” application sits much closer to the backend than to the client. Under such conditions, it may be desired to make the read results stable at the backend or middle tier. Depending upon the specifics of the application, it may be more convenient to have the extra logging needed for the persistent decision on which backend server to visit next not be logged at the client, but rather to log it elsewhere. A decision service can be employed for this purpose.

For example, one way of doing this is for the backend to provide a web service that supports a generalized idempotent request to save read results. Alternatively, this could be a request supported by an existing web service. Then the call to this web service can be encapsulated within an e-proc and permit exploratory reads leading up to the invocation of the web service. This web service would then make the appropriate information stable for subsequent replay, and permit the now stable result to determine subsequent choice of web service to visit. The service need only capture information needed to guide LLcom execution, not the entire LLcom state.

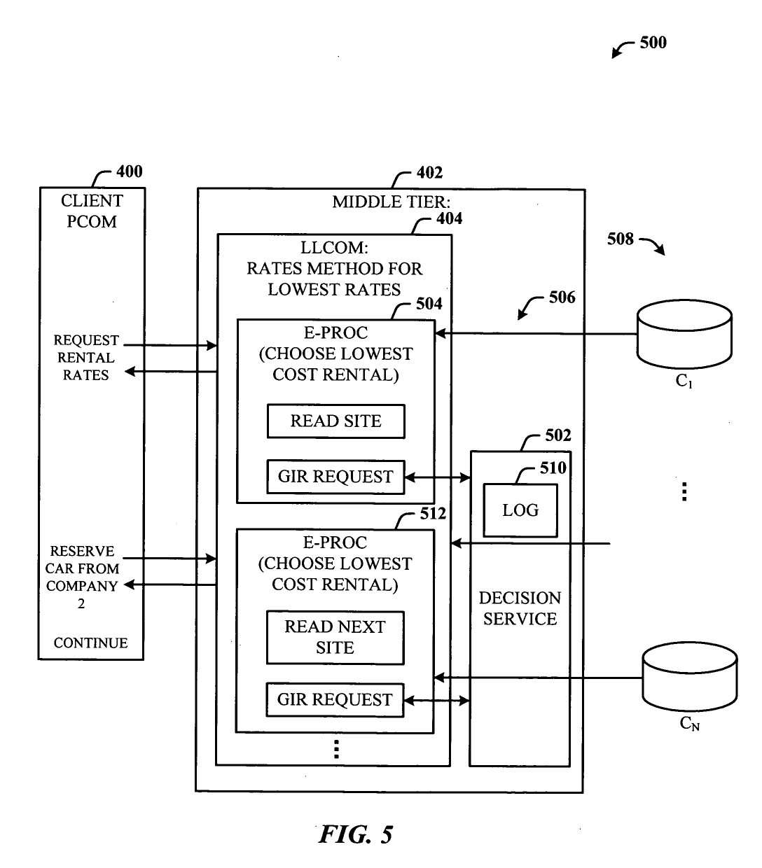

FIG. 5 illustrates a system 500 that employs a decision service 502 for logging information at a location other than at a client 400. The decision service 502 can be provided such that no new system infrastructure is required beyond what has already been described. The decision service 502 can be implemented at the middle tier 402, which accepts GIR requests (denoted GIR REQUEST) via an e-proc 504 of the LLcom method 404. A GIR request to the decision service 502 can be embedded within the e-proc 504, just like the backend services dealt with above. Its function includes returning in its reply message whatever is sent to it in the GIR request.

In one operation, exploratory reads 506 of rental car rates from car company sites 508 (denoted C₁, . . . ,C_{N}) are performed, followed by GIR requests to the decision service 502 to store rate information in a log 510. The method 404 continues execution choosing the next E-Proc 512 to execute, and hence the next backend site 508 to visit by using the result just stored in the log 510. This can permit rate checking to be in the same LLcom method as the actual rental request.

The responsibility of the decision service 502 is to make the GIR requests that it receives stable. Whenever it receives a GIR request with a given request ID, the service 502 will return the argument given to it in the first successful execution of the GIR request with that same request ID. The decision service 502 makes this argument stable and returns the argument as its reply on the first call with its request ID and on any subsequent calls with the same request ID. For flexibility, the argument accompanying the request ID can be a variable length character string, permitting essentially any information to be stored.

The idea is to record only enough information so that an impending decision as to which backend server(s) to visit next can be replayed correctly. Thus, it is expected that typically, very little information would need to be recorded at this service 502. Indeed, it is expected that many middle tier LLcom's would not need to invoke such a service at all. However it is an option, if there is no other convenient alternative.

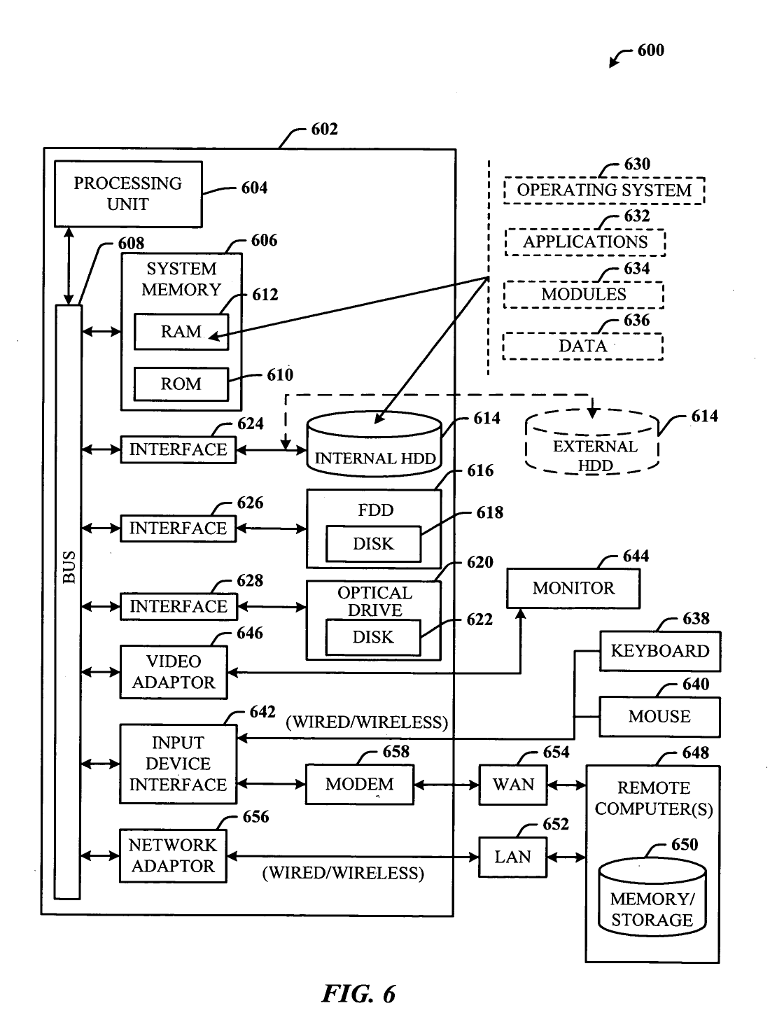

Referring now to FIG. 6, there is illustrated a block diagram of a computer operable to execute the disclosed wrap-up architecture. In order to provide additional context for various aspects thereof, FIG. 6 and the following discussion are intended to provide a brief, general description of a suitable computing environment 600 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 6, the exemplary environment 600 for implementing various aspects includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors. Dual microprocessors and other multi-processor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 includes read-only memory (ROM) 610 and random access memory (RAM) 612. A basic input/output system (BIOS) is stored in a non-volatile memory 610 such as ROM, EPROM, EEPROM, which BIOS contains the basic routines that help to transfer information between elements within the computer 602, such as during start-up. The RAM 612 can also include a high-speed RAM such as static RAM for caching data.

The computer 602 further includes an internal hard disk drive (HDD) 614 (e.g., EIDE, SATA), which internal hard disk drive 614 may also be configured for external use in a suitable chassis (not shown), a magnetic floppy disk drive (FDD) 616, (e.g., to read from or write to a removable diskette 618) and an optical disk drive 620, (e.g., reading a CD-ROM disk 622 or, to read from or write to other high capacity optical media such as the DVD). The hard disk drive 614, magnetic disk drive 616 and optical disk drive 620 can be connected to the system bus 608 by a hard disk drive interface 624, a magnetic disk drive interface 626 and an optical drive interface 628, respectively. The interface 624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 612, including an operating system 630, one or more application programs 632, other program modules 634 and program data 636. All or portions of the operating system, applications, modules, and/or data can also be cached in the RAM 612. It is to be appreciated that the innovation can be implemented with various commercially available operating systems or combinations of operating systems.

A user can enter commands and information into the computer 602 through one or more wired/wireless input devices, e.g., a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces, such as a parallel port, an IEEE 1394 serial port, a game port, a USB port, an IR interface, etc.

A monitor 644 or other type of display device is also connected to the system bus 608 via an interface, such as a video adapter 646. In addition to the monitor 644, a computer typically includes other peripheral output devices (not shown), such as speakers, printers, etc.

The computer 602 may operate in a networked environment using logical connections via wired and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, e.g., a wide area network (WAN) 654. Such LAN and WAN networking environments are commonplace in offices and companies, and facilitate enterprise-wide computer networks, such as intranets, all of which may connect to a global communications network, e.g., the Internet.

When used in a LAN networking environment, the computer 602 is connected to the local network 652 through a wired and/or wireless communication network interface or adapter 656. The adaptor 656 may facilitate wired or wireless communication to the LAN 652, which may also include a wireless access point disposed thereon for communicating with the wireless adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wired or wireless device, is connected to the system bus 608 via the serial port interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11 g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

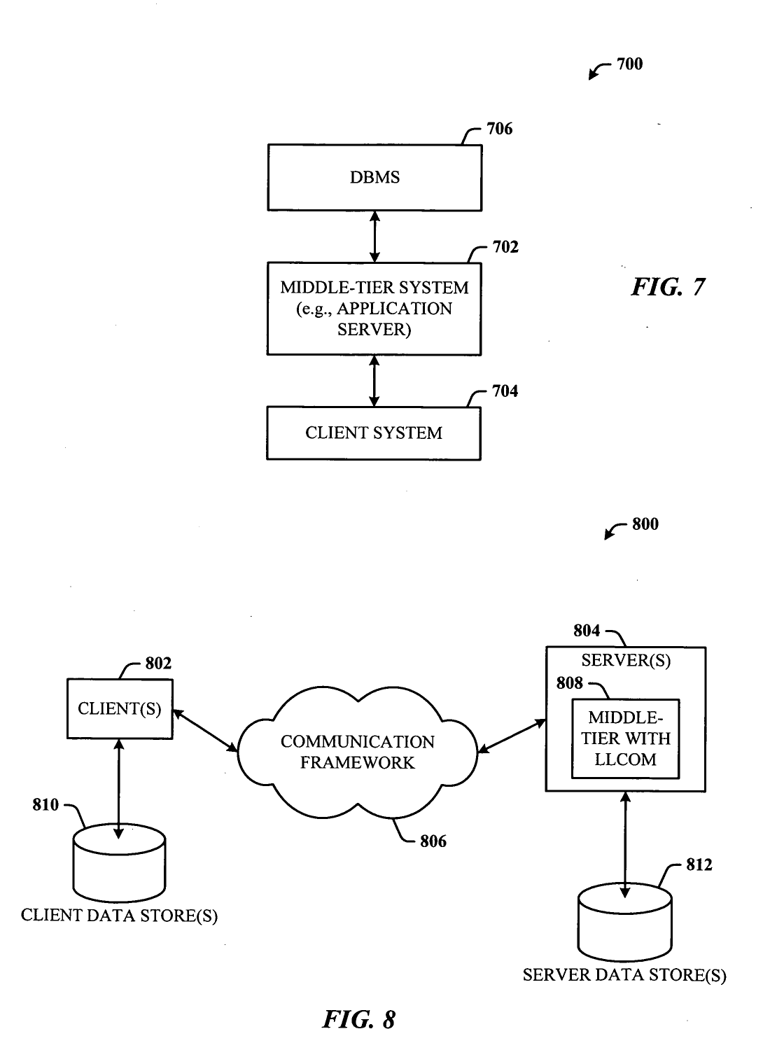

FIG. 7 illustrates an exemplary alternative system 700 that employs wrap-up activity in accordance with an aspect. Here, a middle-tier system 702 serves as an application server between a client system 704 and a database management system (DBMS) 706. The middle-tier system 702 performs the business logic, and facilitates execution of a wrap-up procedure as described hereinabove.

Referring now to FIG. 8, there is illustrated a schematic block diagram of an exemplary two-tier client/server computing environment 800 that can employ wrap-up activity in accordance with another aspect. The system 800 includes one or more client(s) 802. The client(s) 802 can be hardware and/or software (e.g., threads, processes, computing devices). The client(s) 802 can house cookie(s) and/or associated contextual information by employing the subject innovation, for example.

The system 800 also includes one or more server(s) 804. The server(s) 804 can also be hardware and/or software (e.g., threads, processes, computing devices). The servers 804 can house threads to perform transformations by employing the invention, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

The one or more servers 804 can include a middle tier component 808 that includes an LLcom method for processing exploratory and wrap-up procedures, and supporting logging at one of the clients 802, as described above.

Communications can be facilitated via a wired (including optical fiber) and/or wireless technology. The client(s) 802 are operatively connected to one or more client data store(s) 810 that can be employed to store information local to the client(s) 802 (e.g., cookie(s) and/or associated contextual information). Similarly, the server(s) 804 are operatively connected to one or more server data store(s) 812 that can be employed to store information local to the servers 804.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates exactly-once application execution, comprising:
a logless component for processing a last-read activity as part of a method; and
a logging component of a client for logging results of the method to a log.

2. The system of claim 1, wherein the method results are logged by the client before the client initiates a subsequent non-read-only call.

3. The system of claim 1, wherein the logless component is part of a middle-tier application.

4. The system of claim 1, wherein the method is at least one of a read-only method and a non-read-only method.

5. The system of claim 1, wherein when executing the method containing the last-read activity during a replay/recovery process, the results are different.

6. The system of claim 1, wherein the logged results include a first result of a first execution of the method such that when the method is re-executed, the returned result is replaced with the first result.

7. The system of claim 1, wherein the client forces the log prior to revealing state.

8. The system of claim 1, wherein the method performs an update.

9. The system of claim 8, wherein the update is performed via a GIR (general idempotent request).

10. The system of claim 1, wherein the logless component executes a last read activity within a wrap-up procedure to read external state.

11. The system of claim 1, wherein the logless component method further comprises a wrap-up procedure that freely updates its local variables.

12. The system of claim 1, wherein the logless component method further comprises a wrap-up procedure that returns to a part of the method that issues a return for a call of the method.

13. The system of claim 1, further comprising a decision service that logs a decision as to which backend server to visit next at a location other than the client log.

14. A computer-implemented method of providing exactly-one application execution, comprising:
calling an LLcom method of a logless middle-tier component with an LLcom method call;
initiating an internal procedure associated with the LLcom method to read external state;
reading the external state as a last activity prior to the LLcom method returning to the client of the LLcom method call; and
logging results of the LLcom method in a client log for replay.

15. The method of claim 14, wherein the act of logging the result of an examination of external state occurs at a decision procedure which enables program logic to determine which e-proc to execute next.

16. The method of claim 14, wherein the act of reading in an LLcom method is performed after all GIR requests are processed.

17. The method of claim 14, further comprising an act of using the logged results of an original invocation during a replay process to replace results returned by re-execution of the LLcom method.

18. The method of claim 14, further comprising an act of returning from the internal procedure to a part of the LLcom method that immediately issues a return for the LLcom method call.

19. The method of claim 14, further comprising an act of returning results of the internal procedure only to a client component and not exploiting the results to change LLcom state.

20. A computer-executable system, comprising:
computer-implemented means for calling a method of a logless middle-tier component with a call from a client component;
computer-implemented means for initiating an internal procedure to read external state;
computer-implemented means for reading the external state after all GIR requests are processed before returning to the client component;
computer-implemented means for returning the internal procedure to a part of the method that immediately issues a return for the method call; and
computer-implemented means for logging results of the method in a client log of the client component.
